(19) United States
(12) Patent Application Publication
(10) Pub. No.: US 2025/0381527 A1
(43) Pub. Date: Dec. 18, 2025

(54) Fiber membrane prepared based on in-situ growth and application thereof in toluene adsorption

(71) Applicant: Jiangnan University, Wuxi (CN)

(72) Inventors: Dan ZHANG, Wuxi (CN); Yetan XIAO, Wuxi (CN); Fubao SUN, Wuxi (CN); Erpeng ZHOU, Shijiazhuang City (CN); Yun WU, Wuxi (CN); Chang SUN, Wuxi (CN); Alireza Ashori, Tehran (IR); Ali Abdulkhani, Tehran (IR); Soheila Shokrollahzadeh, Tehran (IR)

(21) Appl. No.: 19/313,995

(22) Filed: Aug. 29, 2025

(30) Foreign Application Priority Data
Sep. 10, 2024 (CN) 2024112637669

(51) Int. Cl. B01D 69/08; B01D 53/22; B01D 67/00; B01D 69/14; B01D 71/42; B01J 20/22; B01J 20/28

(52) U.S. Cl. CPC B01D 69/088; B01D 53/228; B01D 67/0093; B01D 67/0095; B01D 69/147; B01D 71/421; B01J 20/226; B01J 20/28038; B01D 2257/708; B01D 2258/06; B01D 2323/12; B01D 2323/30; B01D 2323/39; B01D 2323/40; B01D 2325/12

(57) ABSTRACT

A fiber membrane prepared based on in-situ growth and an application thereof in toluene adsorption are provided. A method for preparing a fiber membrane based on in-situ growth includes the following steps: (1) adding 2-aminoterephthalic acid and polyacrylonitrile (PAN) powder into a solvent, and mixing uniformly to obtain a spinning solution; (2) performing electrospinning on the spinning solution, and drying to obtain a fiber membrane; (3) placing the fiber membrane in an alcohol solution, adding ethylenediamine, and performing thermal crosslinking; after the thermal crosslinking, cleaning and drying to obtain a crosslinked fiber membrane; and (4) placing the crosslinked fiber membrane in a solvent, adding zirconium oxychloride, 2-aminoterephthalic acid, and benzoic acid, and performing in-situ growth to obtain a fiber membrane prepared based on in-situ growth. The fiber membrane prepared based on in-situ growth of the present disclosure has a large toluene adsorption capacity, which may be recycled and reused.

### TECHNICAL FIELD

The present disclosure relates to a fiber membrane prepared based on in-situ growth and an application thereof in toluene adsorption, and belongs to the technical field of functional textiles.

### BACKGROUND

Volatile organic compounds (VOCs) are regarded as one of the pollutants most harmful to human health and ecosystems. In particular, toluene, due to its high toxicity and a wide range of sources (such as chemical production, coating production, home decoration, and the like), is a pollutant that urgently needs to be treated. It is reported that exposure to toluene for more than 8 hours causes negative effects on health, and even brings latent cancer risks to humans. To reduce the emission of benzene-series VOCs, several methods may be adopted, including adsorption, catalytic oxidation, and photocatalysis. The adsorption is deemed as the most effective and economical method for controlling VOC pollution due to its advantages of operational simplicity, high cost-effectiveness, and low energy consumption.

Traditional materials for toluene adsorption include activated carbon, molecular sieves, diatomite, biochar, and resins, which are widely used due to simplicity of preparation. However, applications of these materials are usually severely limited due to the low adsorption capacity, susceptibility to clogging, poor selectivity, and regeneration challenges. In contrast, metal-organic frameworks (MOFs) have significant advantages, and have a surface area of up to 10000 m²/g and a porosity of up to 0.9 cm³/g, surpassing traditional adsorption materials. Additionally, MOFs have the advantages of water stability, favorable chemical properties, and thermal stability, and are widely used for gas storage, catalysis, drug delivery, and wastewater treatment. UiO-66 is different from other MOFs in that a structural unit thereof is composed of [Zr₆ O₄ (OH)₄] metal clusters coordinated and connected with 12 terephthalic acid (H₂ BDC) ligands, and has the highest coordination number of organic ligands and metal clusters. A Zr—O bond in UiO-66 exhibits strong water stability, and also contains many active sites of adsorption. Moreover, UiO-66 is easily modified, desired physical and chemical properties can be obtained through the modification of functional groups, and functionalized Zr-MOFs, such as UiO-66-NH₂ and UiO-66-NO₂ may be prepared by modifying the ligand with other functional groups to coordinate with Zr. Although having many advantages, UiO-66 as an adsorbent exists usually in powder form, which limits its use and recycling in large-scale applications such as gas adsorption.

Currently, MOFs are combined with nanofibers mainly through two ways:
(1) direct electrospinning: specifically, a pre-formed MOF is added to a polymer spinning precursor solution, and a composite nanofiber membrane is directly obtained through electrospinning; this method is operationally simple and has few limitations, but MOF particles easily aggregate, which easily leads to clogging during spinning; with a diameter smaller than that of fibers, MOF particles are usually masked inside the fibers and cannot play a due role; and
(2) in-situ growth: specifically, a pure polymer fiber membrane obtained by spinning is immersed in a solution containing metal salts and organic ligands, and in-situ growth of an MOF on a fiber surface is achieved under high temperature and high pressure; this method is a more promising preparation method, which significantly increases the MOF loading, greatly reduces a degree of MOF aggregation, and improves the compatibility between the MOF and polymer fibers; however, it is difficult for the MOF to grow on an ordinary polymer surface, and it is usually necessary to embed seeds for MOF growth in the fibers, e.g., metal salts or organic ligands are added to the spinning precursor solution to promote MOF growth; and the difficulty of growing different MOF materials varies significantly.

Currently, most studies focus on directly blending MOF powders with polymer matrices to prepare composite membranes. However, in this process, the polymer fully encapsulates and clogs pores of the MOF, thereby reducing the adsorption performance.

For example, the Chinese Patent CN110496541A discloses a modified composite fiber membrane for oil-water separation and a preparation method therefor; NH₂-UiO-66(Zr) is blended with PAN, and a superhydrophobic, superoleophilic nanofiber membrane with good oil-water separation properties is obtained through direct electrospinning; and an adsorption capacity of the composite fiber membrane for silicone oil reaches 33.7 g/g, but an adsorption capacity for VOCs is not studied; and
the Chinese Patent CN118416713A discloses the preparation of a high-flux, fast-adsorption PAN/PEI/UiO-66-NH₂ adsorption membrane and an application in adsorbing Cr(VI); MOFs(UiO-66-NH₂) are encapsulated in fibers through direct electrospinning, and through dynamic adsorption, a flux of the PAN/PEI/UiO-66-NH₂ adsorption membrane reaches 1150 L*m⁻²*h⁻¹ when a pressure is 0.08 MPa and a removal rate of Cr(VI) meets the industrial emission standard, but the adsorption capacity for VOCs is not studied.

Moreover, adsorption mechanisms differ fundamentally for metal ions, oils, and gases; specifically, metal ions are adsorbed through ion exchange; oils are adsorbed through van der Waals forces or π-π stacking; gases are adsorbed through intermolecular forces, such as van der Waals forces; and that is, adsorbents for adsorbing metal ions, oils, and gases are not universal.

Therefore, there is an urgent need to develop an adsorbent material with a large toluene adsorption capacity, recyclability, and reusability.

### SUMMARY

### Technical Problems

Conventional materials for toluene adsorption have deficiencies such as a low adsorption capacity, susceptibility to clogging, poor selectivity, and regeneration challenges;
metal-organic framework (MOF) powders are difficult to recycle and reuse after toluene adsorption; and
Composite membranes formed by blending MOF powders with polymer matrices have poor toluene adsorption performance.

### Technical Solution

In order to solve the above problems, the present disclosure provides a fiber membrane prepared based on in-situ growth, and the fiber membrane may be used for adsorbing toluene, exhibiting good adsorption performance and recyclability.

A first objective of the present disclosure is to provide a method for preparing a fiber membrane based on in-situ growth, and the method includes the following steps:
(1) adding 2-aminoterephthalic acid and polyacrylonitrile (PAN) powder into a solvent, and mixing uniformly to obtain a spinning solution;
(2) performing electrospinning on the spinning solution, and drying to obtain a fiber membrane;
(3) placing the fiber membrane in an alcohol solution, adding ethylenediamine, and performing thermal crosslinking; after the thermal crosslinking, cleaning and drying to obtain a crosslinked fiber membrane; and
(4) placing the crosslinked fiber membrane in a solvent, adding zirconium oxychloride, 2-aminoterephthalic acid, and benzoic acid, and performing in-situ growth to obtain a fiber membrane prepared based on in-situ growth.

In an embodiment of the present disclosure, the solvent in the step (1) is one or a mixture of N,N-dimethylformamide and acetone.

In an embodiment of the present disclosure, a usage ratio of the solvent to the polyacrylonitrile powder in the step (1) is 8-12 mL:1 g, further preferably 10 mL:1 g.

In an embodiment of the present disclosure, a mass ratio of 2-aminoterephthalic acid to polyacrylonitrile powder in the step (1) is 0.10-0.20:1, further preferably 0.15:1.

In an embodiment of the present disclosure, a temperature for mixing uniformly in the step (1) is 55-65° C., further preferably 60° C.

In an embodiment of the present disclosure, parameters of electrospinning in the step (2) are as follows:
a voltage is 10-15 kV, an injection rate is 0.2-2 mL/h, a needle diameter is 0.2-1 mm, a collecting distance is 10-20 cm, a rotation speed of a collecting roller is 60-240 rpm, an ambient temperature is 25-40° C., and a relative humidity is 15-60%.

In an embodiment of the present disclosure, the drying in the step (2) is performed at 60-100° C. to volatilize the solvent.

In an embodiment of the present disclosure, a volume fraction of the alcohol solution in the step (3) is 60-80%, further preferably 75%.

In an embodiment of the present disclosure, the alcohol solution in the step (3) is an ethylene glycol solution or a propylene glycol solution, and the solvent is water.

In an embodiment of the present disclosure, a volume ratio of the alcohol solution to ethylenediamine in the step (3) is 1 mL:0.8-1.2 μL, further preferably 1 mL:1 μL.

In an embodiment of the present disclosure, a usage ratio of the fiber membrane to the alcohol solution in the step (3) is 100 mg:80-120 mL.

In an embodiment of the present disclosure, the thermal crosslinking in the step (3) is performed at 130-140° C. for 1-3 hours, further preferably at 135° C. for 2 hours.

In an embodiment of the present disclosure, the cleaning in the step (3) is performed with ethanol and water.

In an embodiment of the present disclosure, the drying in the step (3) is performed at 60-100° C.

In an embodiment of the present disclosure, the solvent in the step (4) is one or a mixture of N,N-dimethylformamide and acetone.

In an embodiment of the present disclosure, a usage ratio of the crosslinked fiber membrane to the solvent in the step (4) is 100 mg:80-120 mL.

In an embodiment of the present disclosure, a mass ratio of the crosslinked fiber membrane to zirconium oxychloride to 2-aminoterephthalic acid to benzoic acid in the step (4) is 0.1:0.5-1.0:0.3-0.7:1-1.5, further preferably 0.1:0.75:0.5:1.25.

In an embodiment of the present disclosure, the in-situ growth in the step (4) is performed at 90-110° C. for 20-30 hours.

A second objective of the present disclosure is to provide a fiber membrane prepared based on in-situ growth according to the method of the present disclosure.

In an embodiment of the present disclosure, the fiber membrane has a UiO-66-NH₂ crystal structure loaded on a surface of a PAN nanofiber.

A third objective of the present disclosure is to disclose an application of the fiber membrane prepared based on in-situ growth in the field of environmental pollution.

In an embodiment of the present disclosure, the field of environmental pollution includes the field of toluene adsorption.

A fourth objective of the present disclosure is to provide a toluene adsorbent, and the fiber membrane prepared based on in-situ growth of the present disclosure is adopted.

In an embodiment of the present disclosure, the fiber membrane prepared based on in-situ growth of the present disclosure may be directly used as a toluene adsorbent in application scenarios.

A fifth objective of the present disclosure is to provide a method for improving performance of MOFs in adsorbing toluene in polymers, and the fiber membrane prepared based on in-situ growth of the present disclosure is adopted.

A sixth objective of the present disclosure is to provide a method for improving toluene adsorption performance of polyacrylonitrile fiber membranes, and the fiber membrane prepared based on in-situ growth of the present disclosure is adopted.

### Beneficial Effects

(1) The present disclosure loads the UiO-66-NH₂ crystal structure on the surface of PAN nanofibers through electrospinning and in-situ growth, thereby having good toluene adsorption performance.
(2) The fiber membrane prepared based on in-situ growth of the present disclosure has a large toluene adsorption capacity, which may be recycled and reused.
(3) A specific surface area of the fiber membrane prepared based on in-situ growth of the present disclosure reaches 256 m²/g; a toluene adsorption capacity reaches 188 mg/g, and an adsorption rate reaches 4.3×10⁻³/minute; and moreover, after five cycles of adsorption, the toluene adsorption capacity decreases only by 3%.

### BRIEF DESCRIPTION OF THE DRAWINGS

FIG. 1 is an X-ray diffraction (XRD) diagram of a fiber membrane prepared based on in-situ growth in Example 1.

FIG. 2 is an infrared spectrum of a fiber membrane prepared based on in-situ growth in Example 1.

FIG. 3 is a scanning electron microscope (SEM) diagram of a fiber membrane prepared based on in-situ growth in Example 1.

FIG. 4 is a nitrogen adsorption-desorption curve of the fiber membrane prepared based on in-situ growth in Example 1.

FIG. 5 illustrates a toluene adsorption effect of the fiber membrane prepared based on in-situ growth in Example 1.

FIG. 6A compares of toluene adsorption isotherms, adsorption kinetics of the fiber membranes prepared in Example 1 and Comparative Example 3.

FIG. 6B compares of toluene adsorption and adsorption capacities of the fiber membranes prepared in Example 1 and Comparative Example 3.

FIG. 6C compares histograms of toluene adsorption rates of the fiber membranes prepared in Example 1 and Comparative Example 3.

FIG. 7 illustrates effects of different amounts of 2-aminoterephthalic acid on fiber membrane performance.

FIG. 8 is an SEM diagram of the fiber membrane obtained in Comparative Example 6.

FIG. 9 is an SEM diagram of the fiber membrane obtained in Comparative Example 7.

FIG. 10 is an SEM diagram of the fiber membrane obtained in Comparative Example 12.

### DETAILED DESCRIPTIONS OF THE EMBODIMENTS

Preferred embodiments of the present disclosure are described below, and it should be understood that the embodiments are intended to better explain the present disclosure and are not intended to limit the present disclosure.

### Test Methods

### 1. Test of Toluene Adsorption Performance (an Adsorption Capacity and an Adsorption Rate):

### Pretreatment:

samples are evenly placed in a quartz crucible; in an enclosed system, high-temperature purging on the samples is performed with high-purity nitrogen (400 sccm) at 150° C. for 180 minutes, and an average rate of flow directed to the samples is 50 sccm;

### Test:

after the pretreatment, a temperature of the environment where the samples are located is lowered to 25° C., wet nitrogen is introduced into toluene for bubbling, and the nitrogen carrying toluene vapor (40 sccm in total) is proportionally mixed with dry nitrogen (360 sccm), that is, P/P₀ of toluene at 25° C. is 0.1, and nitrogen is continuously blown to a surface of the sample to adsorb toluene; after an adsorption equilibrium is reached, a flow rate is adjusted by switching by means of a four-way valve, and after a wet flow rate and a vapor flow rate (80 sccm in total) are re-proportioned with a dry flow rate (320 sccm), the gas is further blown to the surface of the sample to perform the toluene adsorption with P/P₀ of 0.2 at 25° C. until reaching the adsorption equilibrium.

According to the above process, a ratio of the dry flow rate to the wet flow rate is sequentially adjusted such that P/P₀ of toluene at 25° C. is 0.3-0.4-0.5-0.6-0.7-0.8-0.9-0.8-0.8-0.6-0.5-0.4-0.3-0.2-0.1.

During the test, a high-resolution balance inside a high-performance gas adsorption instrument is used to continuously weigh the samples at different analysis positions, and obtained weighing data is subjected to software processing and buoyancy calculation to obtain an adsorption capacity-time curve, and then the saturated adsorption capacity at each pressure point is selected to obtain an isotherm.

### 2. Test of Toluene Circulation Performance:

### Pretreatment:

samples are evenly placed in a quartz crucible; in an enclosed system, high-temperature purging on the samples is performed with high-purity nitrogen (400 sccm) at 150° C. for 180 minutes, and an average rate of flow directed to the samples is 50 sccm.

### Test:

after the pretreatment, a temperature of the environment where the samples are located is lowered to 25° C., wet nitrogen is introduced into toluene for bubbling, and the nitrogen carrying toluene vapor (320 sccm in total) is proportionally mixed with dry nitrogen (80 sccm), that is, P/P₀ of toluene at 25° C. is 0.8, and nitrogen is continuously blown to a surface of the sample to adsorb toluene; after an adsorption equilibrium is reached, high-purity nitrogen (a flow rate thereof is adjusted to 400 sccm through switching by means of a four-way valve) is blown to the surface of the sample to perform the toluene desorption with P/P₀ of 0 at 25° C. until reaching the desorption equilibrium. The above process is repeated for 5 times.

During the test, a high-resolution balance inside a test instrument is used to continuously weigh the samples at different analysis positions, and obtained weighing data is subjected to software processing and buoyancy calculation to obtain an adsorption capacity-time curve.

### 3. Test of Nitrogen Adsorption-Desorption Curves:

### 77 K Nitrogen Adsorption-Desorption Test Process:

A sample tube containing a sample is installed on the instrument, liquid nitrogen is added to a liquid nitrogen cup until reaching a scale line, a degassing scheme and a test scheme are set, and after the sample tube passes a leak test, a fully automatic in-situ degassing test starts by clicking;
(1) test a free space volume using He gas;
(2) perform in-situ vacuum heating degassing (pressure-controlled heating to prevent sample flying);
(3) perform an adsorption-desorption test;

A relative pressure (P/P₀) set according to the test scheme gradually changes from 0 to nearly 1 atm (one atmospheric pressure), a high-precision pressure sensor is used to measure the pressure changes before and after sample adsorption, and then the gas adsorption or desorption capacity is calculated according to a gas state equation; and an adsorption capacity-relative pressure curve graph is obtained, and a Brunauer-Emmett-Teller (BET) specific surface area and pore size distribution are calculated according to a calculation formula of nitrogen adsorption theory.

### Raw Materials Used in the Examples

N,N-dimethylformamide: ≥97.5, AR;
2-aminoterephthalic acid: AR;
polyacrylonitrile powder: powder, average Mw=150000, AR;
ethylenediamine: AR;
zirconium oxychloride: GR; and
benzoic acid: AR.

In the examples, water is used as a solvent for any solutions involved herein unless otherwise specified, and the % involved herein refers to a mass percentage unless otherwise specified; and any reaction with a reaction temperature not specified herein is a reaction performed at room temperature of 20-30° C.

### EXAMPLE 1

A method for preparing a fiber membrane based on in-situ growth includes the following steps:
(1) 0.15 g of 2-aminoterephthalic acid and 1 g of polyacrylonitrile powder were added to 10 mL of N,N-dimethylformamide, and a mixture obtained was fully stirred and mixed uniformly at 60° C. to obtain a spinning solution;
(2) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%; and obtained fibers were dried in a vacuum oven at 80° C. to volatilize a solvent in the fibers to obtain a fiber membrane (BP) containing 15% by mass of 2-aminoterephthalic acid;
(3) 100 mg of the fiber membrane was placed in 100 mL of an ethylene glycol solution with a volume fraction of 75%, 100 μL of ethylenediamine was added, and thermal crosslinking was performed at 135° C. for 2 hours; after the thermal crosslinking, the fiber membrane was cleaned with ethanol and deionized water for 3 times respectively, and dried in the vacuum oven at 80° C. to obtain a crosslinked fiber membrane (ABP); and
(4) 100 mg of the crosslinked fiber membrane was placed in 100 mL of N,N-dimethylformamide, 0.75 g of zirconium oxychloride, 0.5 g of 2-aminoterephthalic acid, and 1.25 g of benzoic acid were added, and in-situ growth of the crosslinked fiber membrane was performed in a reaction kettle at 100° C. for 24 hours to obtain a fiber membrane prepared based on in-situ growth (UiO-66-NH₂@ABP).

Results of a performance test of the fiber membrane prepared based on in-situ growth are as follows:

### (1) Surface Structure Characterization:

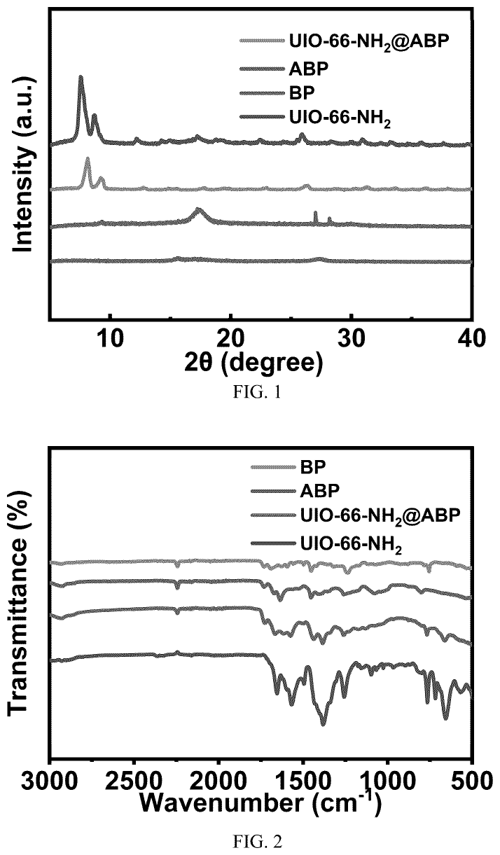

FIG. 1 is an X-ray diffraction (XRD) diagram of a fiber membrane prepared based on in-situ growth, and FIG. 1 shows that characteristic peaks at 7.05° and 8.14° are observed in the fiber membrane, and such characteristic peaks correspond to a characteristic peak of UiO-66-NH₂, which proves the synthesis of a metal-organic framework (MOF).

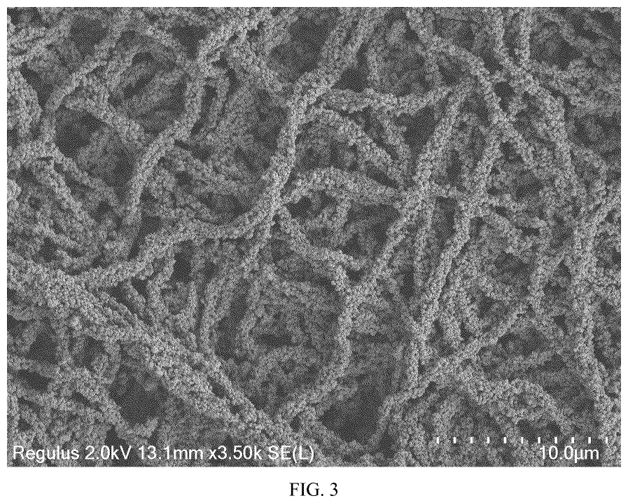

FIG. 2 is an infrared spectrum of a fiber membrane prepared based on in-situ growth. Seen from FIG. 2, characteristic absorption peaks at 620 cm⁻¹ and 770 cm⁻¹ are related to Zr—O bonds, indicating that UiO-66-NH₂ is successfully synthesized on a fiber surface.

Seen from FIGS. 1 and 2, UiO-66-NH₂ indeed exists on a surface of the fiber membrane prepared in Example 1.

### (2) Surface Morphology Characterization:

FIG. 3 is a scanning electron microscope (SEM) diagram of a fiber membrane prepared based on in-situ growth.

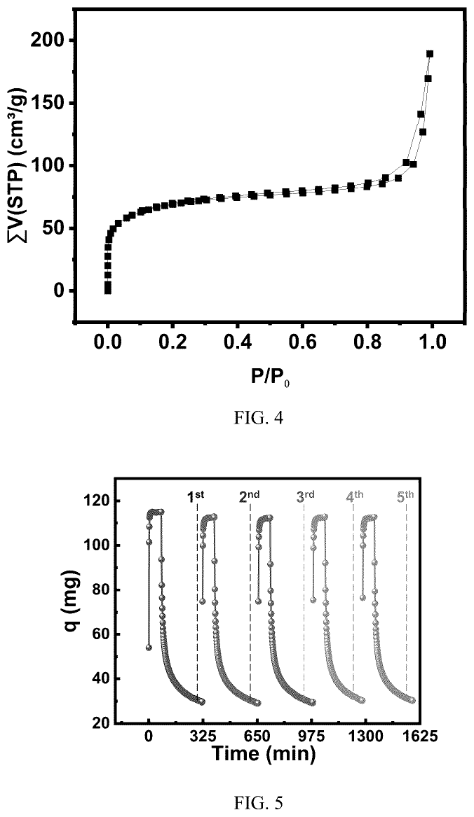

FIG. 4 is a nitrogen adsorption-desorption curve of the fiber membrane prepared based on in-situ growth. Seen from FIG. 4, a specific surface area of the fiber membrane prepared based on in-situ growth (UiO-66-NH₂@ABP) greatly improved, reaching 256 m²/g.

### (3) Adsorption Performance Characterization:

FIG. 5 illustrates an adsorption effect of a fiber membrane prepared based on in-situ growth. Seen from FIG. 5, a toluene adsorption capacity of the fiber membrane prepared based on in-situ growth reaches 178 mg/g, and an adsorption rate reaches 4.3×10⁻³/minute; and moreover, after five times of adsorption, the toluene adsorption capacity decreases only by 3%.

### EXAMPLE 2

A usage amount of 2-aminoterephthalic acid in the step (1) of Example 1 was adjusted to 0.10 g, and other conditions of Example 1 remained unchanged to obtain a fiber membrane prepared based on in-situ growth.

### EXAMPLE 3

A usage amount of 2-aminoterephthalic acid in the step (1) of Example 1 was adjusted to 0.20 g, and other conditions of Example 1 remained unchanged to obtain a fiber membrane prepared based on in-situ growth.

### COMPARATIVE EXAMPLE 1

A method for preparing a fiber membrane based on direct spinning includes the following steps:
(1) 0.75 g of zirconium oxychloride, 0.5 g of 2-aminoterephthalic acid, and 1.25 g of benzoic acid were added to 10 mL of N,N-dimethylformamide, and a reaction in a reaction kettle at 100° C. was performed for 24 hours to synthesize MOF powder: UiO-66-NH₂;
(2) 0.08 g of UiO-66-NH₂ and 0.8 g of polyacrylonitrile powder were added to 10 mL of N,N-dimethylformamide, and a mixture obtained was fully stirred until the liquid was uniform to obtain a spinning solution; and
(3) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%; and obtained fibers were dried in a vacuum oven at 80° C. to volatilize a solvent in the fibers to obtain a fiber membrane prepared based on direct spinning.

### COMPARATIVE EXAMPLE 2

A method for preparing a fiber membrane based on direct spinning includes the following steps:
(1) 0.75 g of zirconium oxychloride, 0.5 g of 2-aminoterephthalic acid, and 1.25 g of benzoic acid were added to 10 mL of N,N-dimethylformamide, and a reaction in a reaction kettle at 100° C. was performed for 24 hours to synthesize MOF powder: UiO-66-NH₂;
(2) 0.24 g of UiO-66-NH₂ and 0.8 g of polyacrylonitrile powder were added to 10 mL of N,N-dimethylformamide, and a mixture obtained was fully stirred until the liquid was uniform to obtain a spinning solution; and
(3) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%; and obtained fibers were dried in a vacuum oven at 80° C. to volatilize a solvent in the fibers to obtain a fiber membrane prepared based on direct spinning.

### COMPARATIVE EXAMPLE 3

A method for preparing a fiber membrane based on direct spinning includes the following steps:
(1) 0.75 g of zirconium oxychloride, 0.5 g of 2-aminoterephthalic acid, and 1.25 g of benzoic acid were added to 10 mL of N,N-dimethylformamide, and a reaction in a reaction kettle at 100° C. was performed for 24 hours to synthesize MOF powder: UiO-66-NH₂;
(2) 0.40 g of UiO-66-NH₂ and 0.8 g of polyacrylonitrile powder were added to 10 mL of N,N-dimethylformamide, and a mixture obtained was fully stirred until the liquid was uniform to obtain a spinning solution; and
(3) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%; and obtained fibers were dried in a vacuum oven at 80° C. to volatilize a solvent in the fibers to obtain a fiber membrane prepared based on direct spinning.

### COMPARATIVE EXAMPLE 4

A usage amount of 2-aminoterephthalic acid in the step (1) of Example 1 was adjusted to 0.05 g, and other conditions of Example 1 remained unchanged to obtain a fiber membrane prepared based on in-situ growth.

Results of performance tests of the fiber membranes obtained in Example 1 and Comparative Examples 1-5 are as follows:

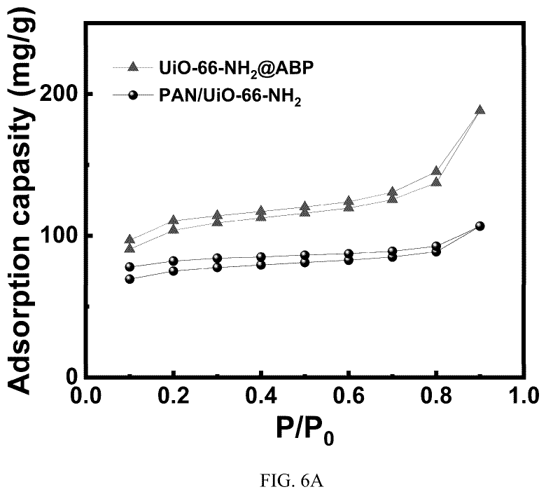

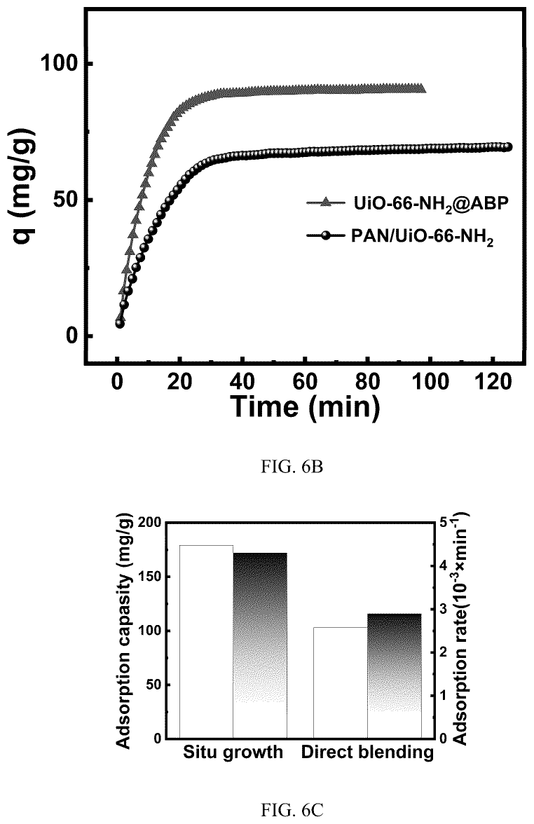

FIG. 6A, FIG. 6B and FIG. 6C compares histograms of toluene adsorption isotherms, adsorption kinetics, and adsorption capacities and rates of the fiber membranes prepared in Example 1 and Comparative Example 3. Seen from FIG. 6A, FIG. 6B and FIG. 6C, a toluene adsorption effect of the fiber membrane prepared based on in-situ growth is much superior to that of direct spinning.

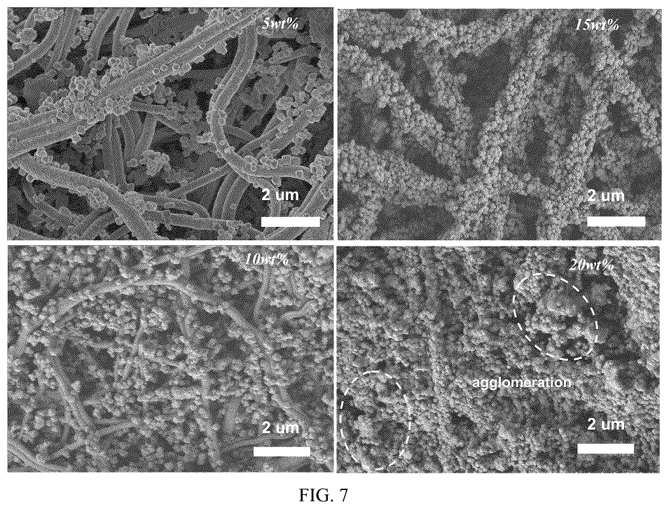

FIG. 7 illustrates effects of different amounts of 2-aminoterephthalic acid on fiber membrane performance. Seen from FIG. 7, when the usage amount of 2-aminoterephthalic acid is 0.05 g, MOF growth is too limited, thereby resulting in poor adsorption performance; when the usage amount of 2-aminoterephthalic acid is 0.2 g, excessive MOF growth leads to a decline in mechanical properties of the fibers (including a breaking strength of 1050 kPa, and a breaking elongation of 16%); when the usage amount of 2-aminoterephthalic acid is 0.15 g, good adsorption performance is achieved; and the MOF material on the fiber surface is relatively uniform, and good mechanical properties are achieved, including a breaking strength of 1200 kPa and a breaking elongation of 20%.

TABLE 1

| | Adsorption capacity | Adsorption rate |
|---|---|---|
| Example | (mg/g) | (10⁻³ × min⁻¹) |
| Example 1 | 178 | 4.3 |
| Example 2 | 54 | 3.5 |
| Example 3 | 166 | 3.9 |
| Comparative Example 1 | 41 | 0.8 |
| Comparative Example 2 | 77 | 1.3 |
| Comparative Example 3 | 103 | 2.9 |
| Comparative Example 4 | 19 | 1.9 |
| UiO-66-NH₂ (powder) | 454 | 7.6 |

### COMPARATIVE EXAMPLE 6

A temperature of the in-situ growth in the step (4) of Example 1 was adjusted to 80° C., and other conditions of Example 1 remained unchanged to obtain a fiber membrane prepared based on in-situ growth.

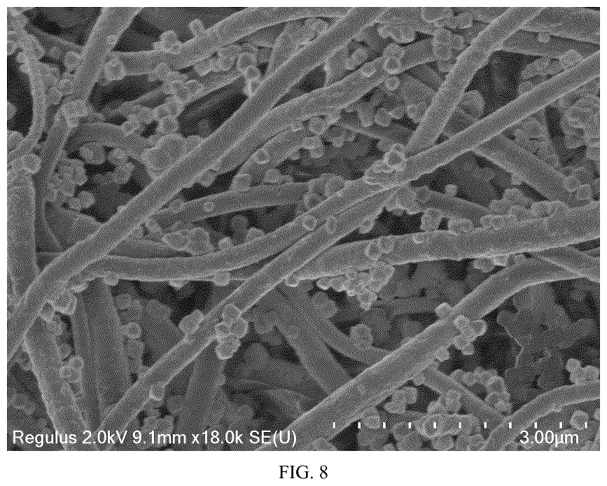

An SEM diagram of the obtained fiber membrane is shown in FIG. 8, and seen from FIG. 8, very limited MOF growth on the fibers results in poor adsorption performance.

### COMPARATIVE EXAMPLE 7

A temperature of the in-situ growth in the step (4) of Example 1 was adjusted to 120° C., and other conditions of Example 1 remained unchanged to obtain a fiber membrane prepared based on in-situ growth.

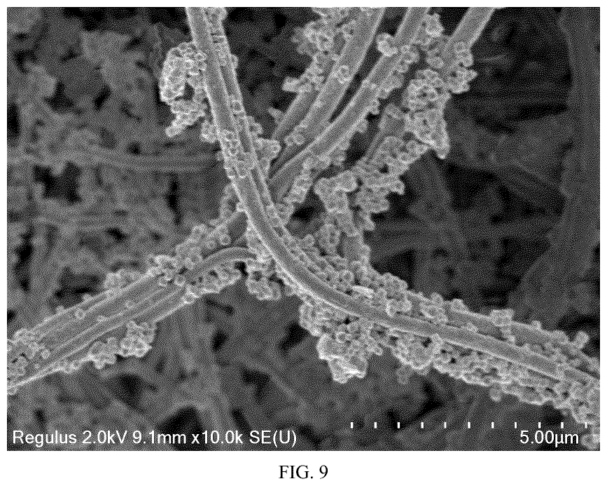

An SEM diagram of the obtained fiber membrane is shown in FIG. 9, and seen from FIG. 9, enhanced but uneven MOF growth on the fibers results in poor adsorption performance.

### COMPARATIVE EXAMPLE 8

A method for preparing a fiber membrane based on in-situ growth includes the following steps:
(1) 0.15 g of zirconium oxychloride and 1 g of polyacrylonitrile powder were added to 10 mL of N,N-dimethylformamide, and a mixture obtained was fully stirred and mixed uniformly at 60° C. to obtain a spinning solution; and
(2) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%.

The results show that adding zirconium oxychloride to the spinning solution makes it impossible to spin uniformly, thereby resulting in failure to form a fiber membrane.

### COMPARATIVE EXAMPLE 9

“0.5 g of 2-aminoterephthalic acid” in the step (4) of Example 1 was adjusted to “1.0 g of 2-aminoterephthalic acid”, and other conditions of Example 1 remained unchanged to obtain a fiber membrane prepared based on in-situ growth.

The results show that excessive MOF growth on the fibers leads to aggregation and poor adsorption performance.

### COMPARATIVE EXAMPLE 10

Addition of “0.5 g of 2-aminoterephthalic acid” in the step (4) of Example 1 was omitted, and other conditions of Example 1 remained unchanged to obtain a fiber membrane prepared based on in-situ growth.

The results show that excessively limited MOF growth on the fibers leads to poor adsorption performance.

### EXAMPLE 4

A method for preparing a fiber membrane based on in-situ growth includes the following steps:
(1) 0.15 g of 2-aminoterephthalic acid and 1 g of polyacrylonitrile were added to 10 mL of N,N-dimethylformamide, and a mixture obtained was fully stirred and mixed uniformly at 60° C. to obtain a spinning solution;
(2) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%; and obtained fibers were dried in a vacuum oven at 80° C. to volatilize a solvent in the fibers to obtain a fiber membrane (BP) containing 15% by mass of 2-aminoterephthalic acid;
(3) 100 mg of the fiber membrane was placed in 100 mL of an ethylene glycol solution with a volume fraction of 75%, 100 μL of ethylenediamine was added, and thermal crosslinking was performed at 130° C. for 3 hours; after the thermal crosslinking, the fiber membrane was cleaned with ethanol and deionized water for 3 times respectively, and dried in the vacuum oven at 80° C. to obtain a crosslinked fiber membrane (ABP); and
(4) 100 mg of the crosslinked fiber membrane was placed in 100 mL of N,N-dimethylformamide, 0.6 g of zirconium oxychloride, 0.4 g of 2-aminoterephthalic acid, and 1.0 g of benzoic acid were added, and in-situ growth of the crosslinked fiber membrane was performed in a reaction kettle at 90° C. for 30 hours to obtain a fiber membrane prepared based on in-situ growth (UiO-66-NH₂@ABP).

### EXAMPLE 5

A method for preparing a fiber membrane based on in-situ growth includes the following steps:
(1) 0.15 g of 2-aminoterephthalic acid and 1 g of polyacrylonitrile powder were added to 10 mL of N,N-dimethylformamide, and a mixture obtained was fully stirred and mixed uniformly at 60° C. to obtain a spinning solution;
(2) electrospinning on the spinning solution was performed under the conditions including a voltage of 12 kV, an injection rate of 1 mL/h, a needle diameter of 0.4 mm, a collecting distance of 15 cm, a rotation speed of a collecting roller of 100 rpm, an ambient temperature of 30° C., and a relative humidity of 40%; and obtained fibers were dried in a vacuum oven at 80° C. to volatilize a solvent in the fibers to obtain a fiber membrane (BP) containing 15% by mass of 2-aminoterephthalic acid;
(3) 100 mg of the fiber membrane was placed in 100 mL of an ethylene glycol solution with a volume fraction of 75%, 100 μL of ethylenediamine was added, and thermal crosslinking was performed at 135° C. for 2 hours; after the thermal crosslinking, the fiber membrane was cleaned with ethanol and deionized water for 3 times respectively, and dried in the vacuum oven at 80° C. to obtain a crosslinked fiber membrane (ABP); and
(4) 100 mg of the crosslinked fiber membrane was placed in 100 mL of N,N-dimethylformamide, 0.9 g of zirconium oxychloride, 0.8 g of 2-aminoterephthalic acid, and 1.4 g of benzoic acid were added, and in-situ growth of the crosslinked fiber membrane was performed in a reaction kettle at 110° C. for 20 hours to obtain a fiber membrane prepared based on in-situ growth (UiO-66-NH₂@ABP).

Results of performance tests of the fiber membranes obtained in Examples 4 and 5 are as follows:

TABLE 2

| Example | Adsorption capacity (mg/g) | Adsorption rate (10⁻³ × min⁻¹) |
|---|---|---|
| Example 4 | 133 | 3.7 |
| Example 5 | 154 | 3.9 |

### COMPARATIVE EXAMPLE 11

The literature (Li W, Wang W, Sun J, et al. Hydrophobic modification of UiO-66 by naphthyl ligand substitution for efficient toluene adsorption in a humid environment[J]. Microporous and Mesoporous Materials, 2021, 326:111357-.DOI:10.1016/j.micromeso.2021.111357.) discloses replacement of UiO-66 with naphthalene to achieve toluene adsorption, but its toluene adsorption capacity is only 143 mg/g under the condition of zero humidity.

### COMPARATIVE EXAMPLE 12

Zirconium oxychloride in Example 1 was adjusted to zirconium tetrachloride, and other conditions of Example 1 remained unchanged to obtain a fiber membrane prepared based on in-situ growth.

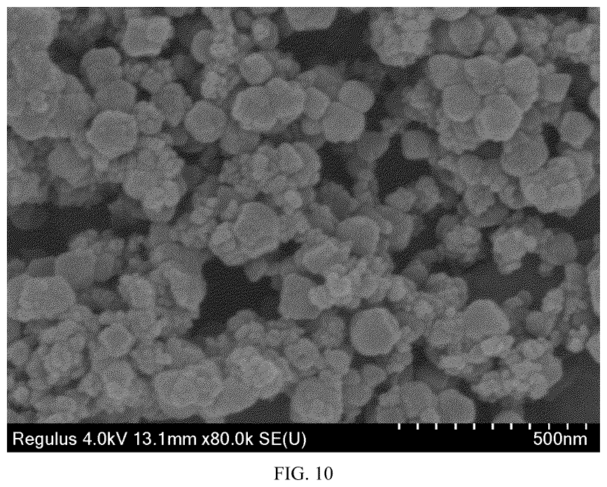

The results are shown in FIG. 10. Seen from FIG. 10, a crystal form of MOF synthesized from zirconium tetrachloride is not obvious, thereby resulting in generation of poor-quality MOF.

### EXAMPLE 6

A method for preparing a fiber membrane based on in-situ growth includes the following steps:
(1) 0.20 g of 2-aminoterephthalic acid and 1 g of polyacrylonitrile powder were added to 12 mL of N,N-dimethylformamide, and a mixture obtained was fully stirred and mixed uniformly at 60° C. to obtain a spinning solution;
(2) electrospinning on the spinning solution was performed under the conditions including a voltage of 15 kV, an injection rate of 1.5 mL/h, a needle diameter of 0.6 mm, a collecting distance of 15 cm, a rotation speed of a collecting roller of 150 rpm, an ambient temperature of 30° C., and a relative humidity of 40%; and obtained fibers were dried in a vacuum oven at 80° C. to volatilize a solvent in the fibers to obtain a fiber membrane (BP);
(3) 100 mg of the fiber membrane was placed in 100 mL of an ethylene glycol solution with a volume fraction of 75%, 100 μL of ethylenediamine was added, and thermal crosslinking was performed at 140° C. for 2 hours; after the thermal crosslinking, the fiber membrane was cleaned with ethanol and deionized water for 3 times respectively, and dried in the vacuum oven at 80° C. to obtain a crosslinked fiber membrane (ABP); and
(4) 100 mg of the crosslinked fiber membrane was placed in 100 mL of N,N-dimethylformamide, 0.6 g of zirconium oxychloride, 0.4 g of 2-aminoterephthalic acid, and 1.0 g of benzoic acid were added, and in-situ growth of the crosslinked fiber membrane was performed in a reaction kettle at 90° C. for 30 hours to obtain a fiber membrane prepared based on in-situ growth (UiO-66-NH₂@ABP).

### EXAMPLE 7

A method for preparing a fiber membrane based on in-situ growth includes the following steps:
(1) 0.10 g of 2-aminoterephthalic acid and 1 g of polyacrylonitrile powder were added to 8 mL of N,N-dimethylformamide, and a mixture obtained was fully stirred and mixed uniformly at 60° C. to obtain a spinning solution;
(2) electrospinning on the spinning solution was performed under the conditions including a voltage of 11 kV, an injection rate of 1.2 mL/h, a needle diameter of 0.5 mm, a collecting distance of 15 cm, a rotation speed of a collecting roller of 100 rpm, an ambient temperature of 30° C., and a relative humidity of 45%; and obtained fibers were dried in a vacuum oven at 80° C. to volatilize a solvent in the fibers to obtain a fiber membrane (BP);
(3) 100 mg of the fiber membrane was placed in 120 mL of an ethylene glycol solution with a volume fraction of 75%, 100 μL of ethylenediamine was added, and thermal crosslinking was performed at 135° C. for 3 hours; after the thermal crosslinking, the fiber membrane was cleaned with ethanol and deionized water for 3 times respectively, and dried in the vacuum oven at 85° C. to obtain a crosslinked fiber membrane (ABP); and
(4) 100 mg of the crosslinked fiber membrane was placed in 100 mL of N,N-dimethylformamide, 0.5 g of zirconium oxychloride, 0.4 g of 2-aminoterephthalic acid, and 1.1 g of benzoic acid were added, and in-situ growth of the crosslinked fiber membrane was performed in a reaction kettle at 95° C. for 30 hours to obtain a fiber membrane prepared based on in-situ growth (UiO-66-NH₂@ABP).

Results of performance tests of the fiber membranes prepared in Examples 6 and 7 are as follows:

The fiber membranes prepared in Examples 6 and 7 exhibit good toluene adsorption effect.

Although the present disclosure has been disclosed in preferred examples, they are not intended to limit the present disclosure. Anyone skilled in the art can make various changes and modifications without departing from the spirit and scope of the present disclosure. Therefore, the scope of protection of the present disclosure should be defined by the claims.

What is claimed is:

1. A method for preparing a fiber membrane based on in-situ growth, comprising the following steps:
(1) adding 2-aminoterephthalic acid and polyacrylonitrile (PAN) powder into a solvent, and mixing uniformly to obtain a spinning solution, wherein a mass ratio of 2-aminoterephthalic acid to polyacrylonitrile powder is 0.10-0.20:1;
(2) performing electrospinning on the spinning solution, and drying to obtain a fiber membrane;
(3) placing the fiber membrane in an alcohol solution, adding ethylenediamine, and performing thermal crosslinking; after the thermal crosslinking, cleaning and drying to obtain a crosslinked fiber membrane; and
(4) placing the crosslinked fiber membrane in a solvent, adding zirconium oxychloride, 2-aminoterephthalic acid, and benzoic acid, and performing in-situ growth to obtain the fiber membrane based on in-situ growth, wherein the in-situ growth is performed at 90-110° C. for 20-30 hours.

2. The method according to claim 1, wherein a usage ratio of the solvent to the polyacrylonitrile powder in the step (1) is 8-12 mL:1 g.

3. The method according to claim 1, wherein parameters of electrospinning in the step (2) are as follows:
a voltage is 10-15 kV, an injection rate is 0.2-2 mL/h, a needle diameter is 0.2-1 mm, a collecting distance is 10-20 cm, a rotation speed of a collecting roller is 60-240 rpm, an ambient temperature is 25-40° C., and a relative humidity is 15-60%.

4. The method according to claim 1, wherein the thermal crosslinking in the step (3) is performed at 130-140° C. for 1-3 hours.

5. The method according to claim 1, wherein a mass ratio of the crosslinked fiber membrane to zirconium oxychloride to 2-aminoterephthalic acid to benzoic acid in the step (4) is 0.1:0.5-1.0:0.3-0.7:1-1.5.

6. A fiber membrane based on in-situ growth prepared according to the method of claims 1.

7. An application of the fiber membrane based on in-situ growth according to claim 6 in the field of environmental pollution.

8. A toluene adsorbent, wherein the fiber membrane based on in-situ growth according to claim 6 is adopted.

9. A method for improving performance of metal-organic frameworks (MOFs) in adsorbing toluene in polymers, wherein the fiber membrane based on in-situ growth according to claim 6 is adopted.

10. A method for improving toluene adsorption performance of polyacrylonitrile fiber membranes, wherein the fiber membrane based on in-situ growth according to claim 6 is adopted.
